(19) United States
(12) Patent Application Publication
(10) Pub. No.: US 2020/0005163 A1
(43) Pub. Date: Jan. 2, 2020

(54) INFERENCE-USE KNOWLEDGE GENERATION APPARATUS, INFERENCE-USE KNOWLEDGE GENERATION METHOD, AND COMPUTER-READABLE RECORDING MEDIUM

(71) Applicant: NEC Corporation, Minato-ku, Tokyo (JP)

(72) Inventor: Itaru HOSOMI, Tokyo (JP)

(73) Assignee: NEC Corporation, Minato-ku, Tokyo (JP)

(21) Appl. No.: 16/484,512

(22) PCT Filed: Feb. 1, 2018
(86) PCT No.: PCT/JP2018/003337

§ 371 Date: Aug. 8, 2019

(30) Foreign Application Priority Data
Feb. 10, 2017 (JP) 2017-023409

(51) Int. Cl. G06N 5/02; G06N 20/00; G06N 5/04; G06F 16/9537

(52) U.S. Cl. CPC G06N 5/02; G06F 16/9537; G06N 5/04; G06N 20/00

(57) ABSTRACT

An inference-use knowledge generation apparatus 10 includes a data extraction unit 11 configured to extract, based on a set parameter, data corresponding to a designated position or region from a first data set including data regarding a stuff in a predetermined space in order to generate inference-use knowledge that is to be used in an inference that is made by a calculating machine, and a knowledge generation unit 12 configured to specify, from a second data set that includes a plurality of entities that form the space and have been grouped into groups of related entities, a group of entities described by words included in data that was extracted previously, and to generate inference-use knowledge indicating a spatial relationship between entities based on the specified group and a term expressing a preregistered spatial relationship.

### TECHNICAL FIELD

The invention relates to an inference-use knowledge generation apparatus and an inference-use knowledge generation method for generating inference-use knowledge that is to be used in an inference that is made by a calculating machine, and also relates to a computer-readable recording medium that includes a program recorded thereon for realizing this apparatus and method.

### BACKGROUND ART

Conventionally, processing aimed at capturing movements of people and stuffs has been performed for store opening plans, crime investigations, evacuation plans and instructions at the time of a disaster, environment management, and the like. In order to execute such processing, geospatial information is required. Many web sites publish geospatial information that can be used by a calculating machine on the Internet (e.g., see Non-Patent Documents 1 to 3).

Also, conventionally, attempts have been made to execute an inference using a calculating machine (see Patent Documents 1 to 4). If an inference is made by a calculating machine, various situations can be deduced based on information obtained from facts. Thus, an inference made by a calculating machine is useful for the above-described store opening plans, crime investigations, evacuation at the time of a disaster, environment management, and the like, and the accuracy of a simulation is expected to be improved utilizing an inference. Also, in recent years, an inference by a calculating machine can be easily utilized due to an improvement in the processing capacity of calculating machines.

### LIST OF RELATED ART DOCUMENTS

### Patent Document

Patent Document 1: Japanese Patent Laid-Open Publication No. H9-213081

Patent Document 2: Japanese Patent Laid-Open Publication No. H10-333911

Patent Document 3: Japanese Patent Laid-Open Publication No. 2000-242499

Patent Document 4: Japanese Patent Laid-Open Publication No. 2015-502617

### Non Patent Document

Non-Patent Document 1: “Open Street Map”, [online], Open Street Map contributors, Retrieved on Nov. 18, 2016, Internet <URL: http://www.openstreetmap.org/>

Non-Patent document 2: “GeoNLP”, [online], National Institute of Informatics, Retrieved on Nov. 18, 2016, Internet <URL: http://www.openstreetmap.org/>

Non-Patent Document 3: “Linked Open Addresses Japan”, [online], Open Addresses, Retrieved on Nov. 18, 2016, Internet <URL: http://uedayou.net/loa/>

### SUMMARY OF INVENTION

### Problems to be Solved by the Invention

Incidentally, in order to make an inference using a calculating machine, it is necessary to generate knowledge regarding stuffs that cannot be understood using data indicating just facts. That is, in order to make an inference using a calculating machine for the above-described store opening plans, crime investigations, evacuation at the time of a disaster, environment management, and the like, it is necessary to generate knowledge regarding stuffs in a space. However, if knowledge is generated on demand at the time of execution of an inference, the processing time increases and the processing cost significantly increases.

An example object of the invention is to provide an inference-use knowledge generation apparatus, an inference-use knowledge generation method, and a computer readable recording medium that solve the above-described problems, and can shorten the processing time and reduce the processing cost required when an inference about things in a space is made by a calculating machine.

### Means for Solving the Problems

In order to achieve the above-described object, an inference-use knowledge generation apparatus according to an example aspect of the invention is an apparatus for generating inference-use knowledge that is to be used in an inference that is made by a calculating machine, and the apparatus includes

a data extraction unit configured to extract, based on a set parameter, data corresponding to a designated position or region from a first data set including data regarding a stuff in a predetermined space, and

a knowledge generation unit configured to specify, from a second data set that includes a plurality of entities that form the space and have been grouped into groups of related entities, a group of entities described by words included in the extracted data, and to generate the inference-use knowledge that indicates a spatial relationship between the entities based on the specified group and a term expressing a preregistered spatial relationship.

Also, in order to achieve the above-described object, an inference-use knowledge generation method according to an example aspect of the invention is a method for generating inference-use knowledge that is to be used in an inference that is made by a calculating machine, and the method includes

(a) a step of extracting, based on a set parameter, data corresponding to a designated position or region from a first data set including data regarding a stuff in a predetermined space, and

(b) a step of specifying, from a second data set that includes a plurality of entities forming that form the space and have been grouped into groups of related entities, a group of entities described by words included in the extracted data, and generating the inference-use knowledge that indicates a spatial relationship between the entities based on the specified group and a term expressing a preregistered spatial relationship.

Furthermore, in order to achieve the above-described object, a computer-readable recording medium according to an example aspect of the invention is a computer-readable recording medium that includes a program recorded thereon for, with use of a computer, generating inference-use knowledge that is to be used in an inference that is made by a calculating machine, the program including instructions that cause the computer to carry out the steps of:

(a) a step of extracting, based on a set parameter, data corresponding to a designated position or region from a first data set including data regarding a stuff in a predetermined space, and

(b) a step of specifying, from a second data set that includes a plurality of entities that form the space and have been grouped into groups of related entities, a group of entities described by words included in the extracted data, and generating the inference-use knowledge that indicates a spatial relationship between the entities based on the specified group and a term expressing a preregistered spatial relationship.

### Advantageous Effects of the Invention

As described above, according to the invention, it is possible to shorten the processing time and reduce the processing cost required when an inference about stuffs in a space is made by a calculating machine.

### BRIEF DESCRIPTION OF THE DRAWINGS

FIG. 1 is a block diagram illustrating a schematic configuration of an inference-use knowledge generation apparatus in an example embodiment of the invention.

FIG. 2 is a block diagram illustrating a specific configuration of an inference-use knowledge generation apparatus in an example embodiment of the invention.

FIG. 3 is a diagram illustrating examples of spatial relationship terms and inference-use knowledge in an example embodiment of the invention.

FIG. 4 is a flowchart illustrating operations of an inference-use knowledge generation apparatus in an example embodiment of the invention.

FIG. 5 is a block diagram illustrating an example of a computer that realizes an inference-use knowledge generation apparatus in an example embodiment of the invention.

### EXAMPLE EMBODIMENT

### Example Embodiment

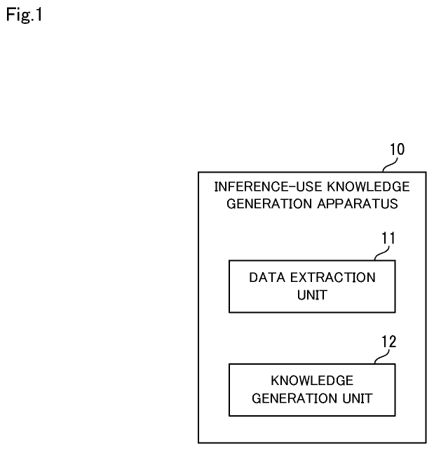

Hereinafter, an inference-use knowledge generation apparatus, an inference-use knowledge generation method, and a program in an example embodiment of the invention will be described with reference to FIGS. 1 to 5.

### Apparatus Configuration

First, a schematic configuration of an inference-use knowledge generation apparatus in this example embodiment will be described with reference to FIG. 1. FIG. 1 is a block diagram illustrating a schematic configuration of an inference-use knowledge generation apparatus in an example embodiment of the invention.

An inference-use knowledge generation apparatus 10 shown in FIG. 1 in this example embodiment is an apparatus for generating inference-use knowledge that is to be used in an inference that is made by a calculating machine. As shown in FIG. 1, the inference-use knowledge generation apparatus 10 includes a data extraction unit 11 and a knowledge generation unit 12.

The data extraction unit 11 extracts, from a first data set including data regarding stuffs in a predetermined space, data corresponding to a designated position or region based on a set parameter.

Also, first, the knowledge generation unit 12 specifies, from a second data set that includes a plurality of entities that form a space and have been grouped into groups of related entities, a group of entities described by words included in the data extracted by the data extraction unit 11. Next, the knowledge generation unit 12 generates inference-use knowledge indicating a spatial relationship between entities based on the specified group and a term expressing a preregistered spatial relationship.

In this manner, if a data set regarding stuffs in a predetermined space and a data set including a plurality of entities forming a space are prepared, the inference-use knowledge generation apparatus 10 in this example embodiment can generate inference-use knowledge in advance. Thus, according to this example embodiment, it is possible to shorten the processing time and reduce the processing cost required to generate knowledge required when an inference about stuffs in a space is made by a calculating machine.

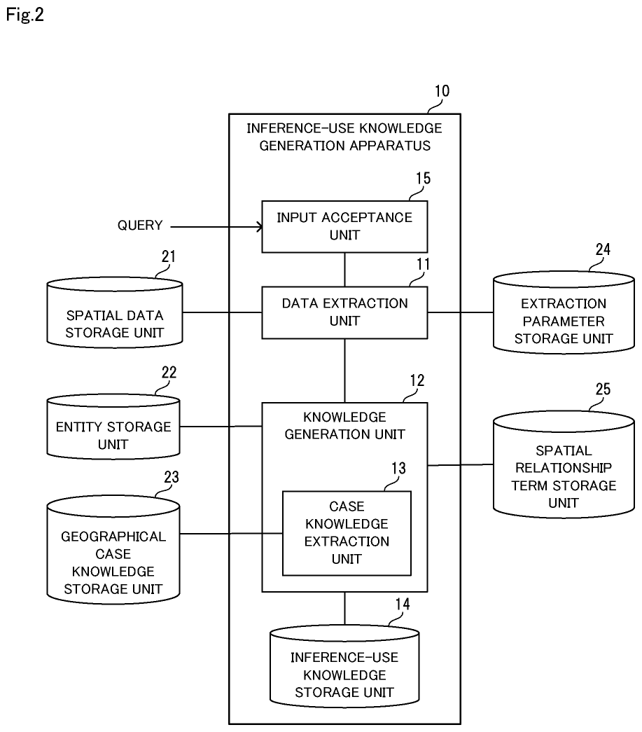

Next, a specific configuration of the inference-use knowledge generation apparatus in this example embodiment will be described with reference to FIG. 2. FIG. 2 is a block diagram illustrating a specific configuration of the inference-use knowledge generation apparatus in an example embodiment of the invention.

As shown in FIG. 2, in this example embodiment, the inference-use knowledge generation apparatus 10 includes an inference-use knowledge storage unit 14 in which inference-use knowledge generated by the knowledge generation unit 12 is stored and an input acceptance unit 15, in addition to the data extraction unit 11 and the knowledge generation unit 12. Also, in this example embodiment, the inference-use knowledge generation apparatus 10 is constructed by introducing a program according to this example embodiment into a computer.

Furthermore, in this example embodiment, the inference-use knowledge generation apparatus 10 is connected to a spatial data storage unit 21, an entity storage unit 22, a geographical case knowledge storage unit 23, an extraction parameter storage unit 24, and a spatial relationship term storage unit 25. In addition, the spatial data storage unit 21, the entity storage unit 22, the geographical case knowledge storage unit 23, the extraction parameter storage unit 24, and the spatial relationship term storage unit 25 are each constructed by a storage device of a computer that is external to the inference-use knowledge generation apparatus 10. Note that the storage units may be constructed by a storage device of a computer that is included in the inference-use knowledge generation apparatus 10.

The spatial data storage unit 21 stores a first data set including data (referred to as “spatial data” hereinafter) regarding stuffs in a predetermined space. A specific example of spatial data is electronic map data.

The entity storage unit 22 stores a second data set. As described above, the second data set is a collection of multiple groups of related entities. Specifically, for example, a group may be formed by two related entities (a pair of entities), and in this case, the second data set includes a plurality of pairs of entities.

Also, examples of a pair of entities include combinations of terms whose collocation frequency is greater than or equal to a certain level in past blog articles, past news articles, and the history of queries and the like used in past inferences. In a group of three or more entities, the group includes a combination of three or more terms whose collocation frequency is greater than or equal to a certain level, for example. Examples of terms include terms regarding a geographical space, such as stations, airports, prefectures, municipalities, buildings, stadiums, and landmarks.

The geographical case knowledge storage unit 23 stores case knowledge regarding a predetermined geographical space (e.g., municipalities, prefectures, and districts). Examples of case knowledge include “City A and City B have a contract on support for fire fighting” and “City A and City B have a contract to share supplies at the time of a disaster”.

The extraction parameter storage unit 24 stores parameters used in data extraction performed by the data extraction unit 11. Parameters are used to specify data to be extracted, and a specific example thereof is “<20 km from center of (input place name)” (indicating a range of less than 20 km from the center).

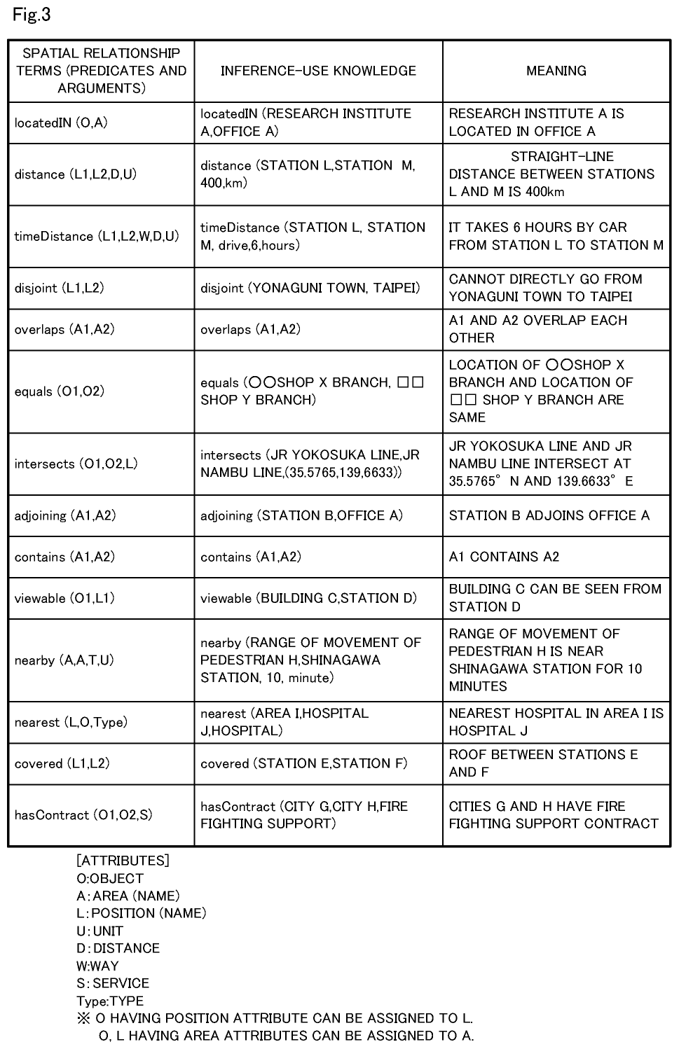

The spatial relationship term storage unit 25 stores spatial relationship terms. A spatial relationship term is a term indicating a spatial relationship using a predicate-argument structure. Specific examples of a spatial relationship term will be described later with reference to FIG. 3. Note that a spatial relationship indicates a positional relationship in a space, or a temporal/spatial distance or connection.

The input acceptance unit 15 accepts a query input from the outside, specifically, accepts text data indicating a designated position or region and transmits the accepted query to the data extraction unit 11. In this example embodiment, the data extraction unit 11 first acquires a parameter from the extraction parameter storage unit 24. Next, the data extraction unit 11 compares the acquired query and parameter with spatial data stored in the spatial data storage unit 21, and extracts spatial data corresponding to the query and parameter.

For example, assume the query is “City A” and the parameter is “<20 km from center of (input place name)”. In this case, the data extraction unit 11 specifies the latitude and longitude of the center of City A, and extracts, as data, the names of places, the names of POIs (Points Of Interfaces), and the like located within a radius of 20 km from the specified latitude and longitude.

In this example embodiment, the knowledge generation unit 12 compares the spatial data extracted by the data extraction unit 11 with pairs of entities stored in the entity storage unit 22, and specifies a specific pair of entities described by words included in the extracted spatial data. For example, if the extracted data includes City A, and “City A, City A General Hospital” exists as a pair of entities, the knowledge generation unit 12 specifies this pair of entities.

Also, the knowledge generation unit 12 applies the specified pair of entities to a spatial relationship term stored in the spatial relationship term storage unit 25, and generates a predicate-argument structure in which the two entities forming the specified pair of entities are used as terms. This generated predicate-argument structure serves as inference-use knowledge. Also, in this example embodiment, the knowledge generation unit 12 outputs the generated inference-use knowledge to the inference-use knowledge storage unit 14 and causes the inference-use knowledge storage unit 14 to store the generated inference-use knowledge.

Herein, processing for creating inference-use knowledge using a spatial relationship term will be specifically described with reference to FIG. 3. FIG. 3 is a diagram illustrating examples of spatial relationship terms and inference-use knowledge in an example embodiment of the invention. Examples of the spatial relationship terms are shown in the left end column, examples of inference-use knowledge are shown in the center column, and the meanings of inference-use knowledge are shown in the right end column in FIG. 3.

As shown in the left end column in FIG. 3, a spatial relationship term is defined by a predicate and an term that is an essential element therefor. Also, attributes of terms as described in a lower portion of FIG. 3 are also defined in spatial relationship terms, and a predicate is not established depending on words that do not have a corresponding attribute.

Thus, in this example embodiment, the knowledge generation unit 12 first specifies the attribute of each of the entities forming the specified pair of entities, and extracts, from the spatial relationship terms stored in the spatial relationship term storage unit 25, a spatial relationship term corresponding to the entities having the specified attributes. The knowledge generation unit 12 then applies the specified pair of entities to the extracted spatial relationship term, and generates, as inference-use knowledge, a predicate-argument structure shown in the center column in FIG. 3. Also, the knowledge generation unit 12 can specify numerical data such as distances and times using a search site on the Internet, for example. Specifically, the knowledge generation unit 12 searches for the name of an entity using a search site that can be accessed through the Internet and is connected to a map database, and thus can specify the attribute of the entity (O: object, A: area (name), L: position (name), U: unit, D: distance, W: means, Type: type that are shown in FIG. 3). Note that it is assumed that an object O having a position attribute can be assigned to the position (name) L, and an object O and a position (name) L that have area attributes can be assigned to the area (name) A. Also, a service S may be provided as an attribute of an entity. The service S is used to extract topics from announcements on an official website regarding objects, web news, or the like. For example, in the case of “hasContract (O1,O2,S)” shown in FIG. 3, as a result of performing a search using “City G”, “City H”, and “fire fighting support” as attributes O1, O2, and S, whether or not City G and City H have a contract can be checked, and a topic “List of fire fighting mutual support contracts” (http://www.tfd.metro.tokyo.jp/hp-keibouka/sougokyoutei-2.html) can be extracted from the website of the Tokyo Fire Department.

Also, the knowledge generation unit 12 includes a case knowledge extraction unit 13 in this example embodiment. The case knowledge extraction unit 13 extracts, from case knowledge stored in the geographical case knowledge storage unit 23, case knowledge at/in a designated position or region, and stores the extracted case knowledge in the inference-use knowledge storage unit 14 in association with the generated inference-use knowledge.

### Apparatus Operations

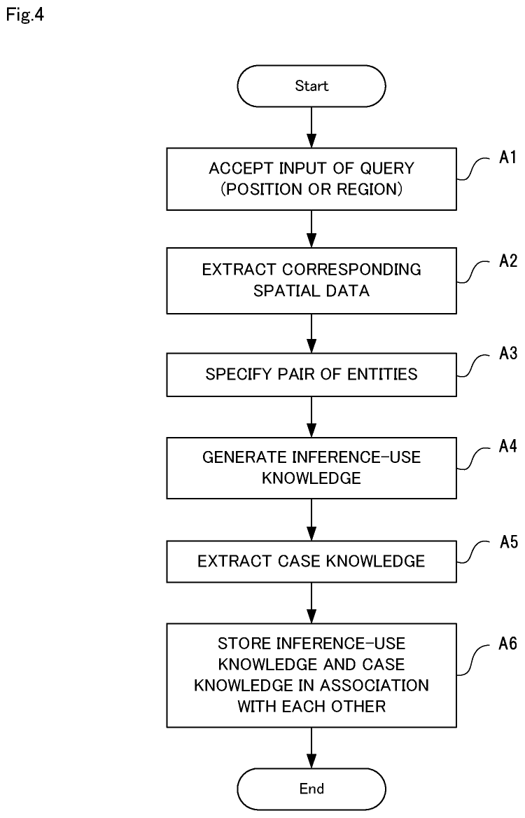

Next, operations of the inference-use knowledge generation apparatus according to an example embodiment of the invention will be described with reference to FIG. 4. FIG. 4 is a flowchart showing operations of the inference-use knowledge generation apparatus in an example embodiment of the invention. In the following description, FIGS. 1 to 3 will be referred to as appropriate. Also, in this example embodiment, an inference-use knowledge generation method is implemented by operating the inference-use knowledge generation apparatus. Thus, a description of the inference-use knowledge generation method in this example embodiment will be replaced with the following description of the operations of the inference-use knowledge generation apparatus 10.

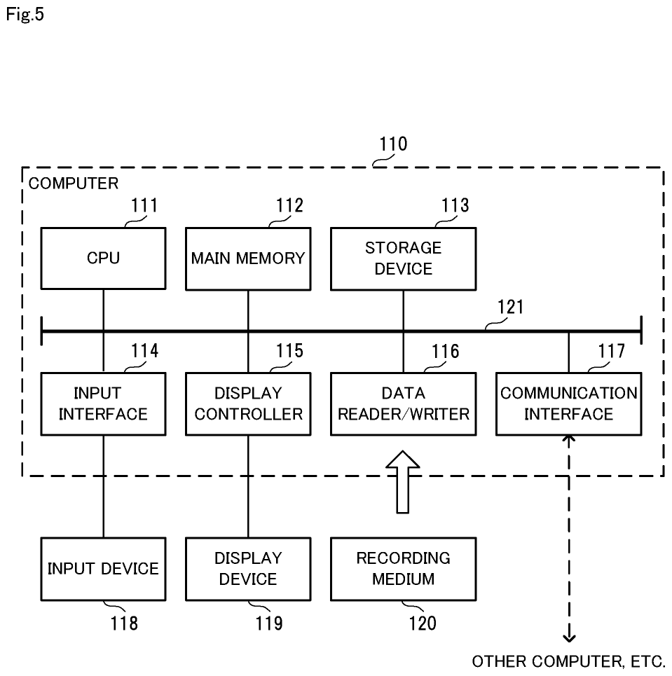

As shown in FIG. 5, first, the input acceptance unit 15 accepts a query (text data indicating a designated position or region) that has been input from the outside, and transmits the accepted query to the data extraction unit 11 (step A1).

Next, the data extraction unit 11 compares the parameter accepted in step A1 and the parameter acquired from the extraction parameter storage unit 24 with spatial data stored in the spatial data storage unit 21, and extracts spatial data corresponding to the query and the parameters (step A2).

Next, the knowledge generation unit 12 compares the spatial data extracted in step A2 with the pairs of entities stored in the entity storage unit 22, and specifies a specific pair of entities described by the words included in the extracted spatial data (step A3).

Next, the knowledge generation unit 12 applies the pair of entities specified in step A3 to a spatial relationship term stored in the spatial relationship term storage unit 25, generates a predicate-argument structure in which the two entities forming this pair of entities are used as terms, and uses this generated predicate-argument structure as inference-use knowledge (step A4).

Next, in the knowledge generation unit 12, the case knowledge extraction unit 13 extracts, from the case knowledge stored in the geographical case knowledge storage unit 23, case knowledge in the query accepted in step A1 (step A5).

Then, the case knowledge extraction unit 13 stores, in the inference-use knowledge storage unit 14, the case knowledge extracted in step A5 in association with the inference-use knowledge generated in step A4 (step A6).

In this manner, when steps A1 to A6 are executed, inference-use knowledge is generated, and thus when an inference about stuffs in a space is made by the calculating machine, it is not necessary to derive a spatial relationship on demand when an inference is made, and the processing time can be shortened and the processing cost can be reduced. Also, in this example embodiment, the generated inference-use knowledge includes a predicate-argument structure, and thus can be directly applied to an inference.

### Specific Example

Next, a specific example will be described. It is assumed that “Kawasaki City” is first input as a query, for example. Also, it is assumed that the spatial data storage unit 21 stores electronic map data, and the extraction parameter storage unit 24 stores “<20 km from center of (input place name)”.

In this case, the data extraction unit 11 extracts, from electronic map data, names of places or POIs located within a radius of 20 km from the center of Kawasaki City, such as Yokohama City, Sagamihara City, Ota Ward, Setagaya Ward, Shinagawa Ward, Komae City, Chofu City, Kawasaki Station, and Yokohama Station.

Also, it is assumed that the knowledge generation unit 12 specifies, as pairs of entities, (Kawasaki Station, Yokohama Station), (Kawasaki Station, Ota General Hospital), (Kawasaki City, Yokohama City), (Kawasaki City, Ota Ward), and the like, for example. In this case, the knowledge generation unit 12 creates, as inference-use knowledge, “timeDistance (Station L, Station M, drive, 6, hours)”, “nearest (Kawasaki City, Ota General Hospital, hospital)”, “adjoining (Kawasaki City, Yokohama City)”, “adjoining (Kawasaki City, Ota Ward)”, and the like using the spatial relationship terms shown in FIG. 3, for example.

Also, in this case, the case knowledge extraction unit 13 extracts, as case knowledge, “hasContract (Kawasaki City, Yokohama City, fire fighting support)”, “hasContract (Kawasaki City, Yokohama City, share supplies at time of disaster)”, and the like, and associates the case knowledge with the above-described inference-use knowledge. Also, the created inference-use knowledge and the extracted case knowledge are stored in the inference-use knowledge storage unit 14.

The fact that “Kawasaki City”, which is a query, has made an agreement about fire fighting support at the time of a fire and sharing of supplies at the time of a disaster with “Yokohama City” in advance is held as knowledge through the above-described processing. Thus, if Kawasaki City urgently seeks support of fire fighting, for example, the fact that Yokohama City is a neighboring city of Kawasaki City and has a fire fighting support contract with Kawasaki City is specified by referencing knowledge in an inference.

### Program

A program in this example embodiment may be a program for causing a computer to carry out steps A1 to A6 shown in FIG. 4. This program is installed in the computer, and executed by the computer, and thereby the inference-use knowledge generation apparatus 10 and the inference-use knowledge generation method in this example embodiment can be realized. In this case, the processor of the computer functions as the data extraction unit 11 and the knowledge generation unit 12, and performs processing. Also, the inference-use knowledge storage unit 14 can be realized by a storage device such as a hard disk included in the computer.

Also, the program in this example embodiment may be executed by a computer system constructed by a plurality of computers. In this case, each of the computers may function as the data extraction unit 11 or the knowledge generation unit 12, for example. Also, the inference-use knowledge storage unit 14 may be constructed on a computer other than the computer that executes the program in this example embodiment.

Here, a computer configured to realize the inference-use knowledge generation apparatus 10 by executing the program in this example embodiment will be described with reference to FIG. 5. FIG. 5 is a block diagram illustrating an example of a computer for realizing the inference-use knowledge generation apparatus in an example embodiment of the invention.

As shown in FIG. 5, the computer 110 includes a CPU (Central Processing Unit) 111, a main memory 112, a storage device 113, an input interface 114, a display controller 115, a data reader/writer 116, and a communication interface 117. These units are connected via a bus 121 to be capable of data communication. Note that the computer 110 may include a GPU (Graphics Processing Unit) or an FPGA (Field-Programmable Gate Array), in addition to the CPU 111 or instead of the CPU 111.

The CPU 111 loads the programs (code) stored in the storage device 113 in this example embodiment to the main memory 112, executes these programs in a predetermined order, and thereby implements various calculations. Typically, the main memory 112 is a volatile storage device such as a DRAM (Dynamic Random Access Memory). Also, a program in this example embodiment is provided in a state of being stored in a computer-readable recording medium 120. Note that the program in this example embodiment may be distributed on the Internet connected via the communication interface 117.

Also, specific examples of the storage device 113 include a semiconductor storage device such as a flash memory, as well as a hard disk drive. The input interface 114 mediates data transmission between the CPU 111 and input devices 118 such as a keyboard and a mouse. The display controller 115 is connected to a display device 119, and controls the display on the display device 119.

The data reader/writer 116 mediates data transmission between the CPU 111 and the recording medium 120, reads out a program from the recording medium 120, and writes the results of processing by the computer 110 to the recording medium 120. The communication interface 117 mediates data transmission between the CPU 111 and another computer.

Also, specific examples of the recording medium 120 include a general-purpose semiconductor storage device such as a CF (Compact Flash (registered trademark)) and an SD (Secure Digital), a magnetic recording medium such as a Flexible Disk, and an optical recording medium such as a CD-ROM (Compact Disk Read Only Memory).

Note that the inference-use knowledge generation apparatus 10 in this example embodiment can be realized by not only a computer on which programs are installed but also hardware corresponding to each unit. Furthermore, a portion of the inference-use knowledge generation apparatus 10 may be realized by a program and the remaining portion thereof may be realized by hardware.

Part or all of the above-described example embodiments can be expressed by Supplementary Notes 1 to 12 below, but are not limited thereto.

### Supplementary Note 1

An inference-use knowledge generation apparatus for generating inference-use knowledge that is to be used in an inference that is made by a calculating machine, the apparatus including:

a data extraction unit configured to extract, based on a set parameter, data corresponding to a designated position or region from a first data set including data regarding a stuff in a predetermined space; and

a knowledge generation unit configured to specify, from a second data set that includes a plurality of entities that form the space and have been grouped into groups of related entities, a group of entities described by words included in the extracted data, and to generate the inference-use knowledge that indicates a spatial relationship between the entities based on the specified group and a term expressing a preregistered spatial relationship.

### Supplementary Note 2

The inference-use knowledge generation apparatus according to Supplementary Note 1,

in which the plurality of entities are grouped into groups of two related entities in the second data set, and

the knowledge generation unit is configured to generate, as the inference-use knowledge, a predicate-argument structure in which the two entities forming the specified group are used as terms.

### Supplementary Note 3

The inference-use knowledge generation apparatus according to Supplementary Note 1 or 2, further including

an inference-use knowledge storage unit configured to store the generated inference-use knowledge.

### Supplementary Note 4

The inference-use knowledge generation apparatus according to Supplementary Note 3,

in which the knowledge generation unit is configured to extract, from case knowledge regarding the space, case knowledge at/in the designated position or region, and store the extracted case knowledge in the inference-use knowledge storage unit in association with the generated inference-use knowledge.

(Supplementary Note 5)

An inference-use knowledge generation method for generating inference-use knowledge that is to be used in an inference that is made by a calculating machine, the method including:

(a) a step of extracting, based on a set parameter, data corresponding to a designated position or region from a first data set including data regarding a stuff in a predetermined space, and

(b) a step of specifying, from a second data set that includes a plurality of entities that form the space and have been grouped into groups of related entities, a group of entities described by words included in the extracted data, and generating the inference-use knowledge that indicates a spatial relationship between the entities based on the specified group and a term expressing a preregistered spatial relationship.

### Supplementary Note 6

The inference-use knowledge generation method according to Supplementary Note 5,

in which the plurality of entities are grouped into groups of two related entities in the second data set, and

in the (b) step, a predicate-argument structure in which the two entities forming the specified group are used as terms is generated as the inference-use knowledge.

### Supplementary Note 7

The inference-use knowledge generation method according to Supplementary Note 5 or 6, further including

(c) a step of storing the generated inference-use knowledge.

### Supplementary Note 8

The inference-use knowledge generation method according to Supplementary Note 7, further including:

(d) a step of extracting, from case knowledge regarding the space, case knowledge at/in the designated position or region,

in which in the (c) step, the extracted case knowledge is stored in association with the generated inference-use knowledge.

### Supplementary Note 9

A non-transitory computer readable recording medium that includes a program recorded thereon for, with use of a computer, generating inference-use knowledge that is to be used in an inference that is made by a calculating machine, the program including instructions that cause the computer to carry out the steps of:

(a) a step of extracting, based on a set parameter, data corresponding to a designated position or region from a first data set including data regarding a stuff in a predetermined space, and

(b) a step of specifying, from a second data set that includes a plurality of entities that form the space and have been grouped into groups of related entities, a group of entities described by words included in the extracted data, and generating the inference-use knowledge that indicates a spatial relationship between the entities based on the specified group and a term expressing a preregistered spatial relationship.

### Supplementary Note 10

The non-transitory computer readable recording medium according to Supplementary Note 9,

in which the plurality of entities are grouped into groups of two related entities in the second data set, and

in the (b) step, a predicate-argument structure in which the two entities forming the specified group are used as terms is generated as the inference-use knowledge.

### Supplementary Note 11

The non-transitory computer readable recording medium according to Supplementary Note 9 or 10, the program including instructions that cause the computer to further carry out the step of:

(c) a step of storing the generated inference-use knowledge.

### Supplementary Note 12

The non-transitory computer readable recording medium according to Supplementary Note 11, the program including instructions that cause the computer to further carry out the step of:

(d) a step of extracting, from case knowledge regarding the space, case knowledge at/in the designated position or region,

in which in the (c) step, the extracted case knowledge is stored in association with the generated inference-use knowledge.

Although the invention of this application has been described with reference to an example embodiment, the invention is not limited to the above-described example embodiment. Various modifications that can be understood by those skilled in the art can be made to the configuration and details of the invention within the scope of the invention.

This application is based upon and claims the benefit of priority from Japanese application No. 2017-023409, filed on Feb. 10, 2017, the disclosure of which is incorporated herein in its entirety by reference.

### INDUSTRIAL APPLICABILITY

As described above, according to the invention, it is possible to shorten the processing time and reduce the processing cost required when an inference about stuffs in a space is made by a calculating machine. The invention is useful for a system in which an inference about stuffs in a space is made by a calculating machine, for example, a system aimed at capturing movements of people and stuffs, for store opening plans, crime investigations, evacuation plans and instructions at the time of a disaster, environment management, and the like.

### REFERENCE NUMERALS

10 Inference-use knowledge generation apparatus
11 Data extraction unit
12 Knowledge generation unit
13 Case knowledge extraction unit
14 Inference-use knowledge storage unit
15 Input acceptance unit
21 Spatial data storage unit
22 Entity storage unit
23 Geographical case knowledge storage unit
24 Extraction parameter storage unit
25 Spatial relationship term storage unit
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An inference-use knowledge generation apparatus for generating inference-use knowledge that is to be used in an inference that is made by a calculating machine, the apparatus comprising:
a data extraction unit configured to extract, based on a set parameter, data corresponding to a designated position or region from a first data set including data regarding a stuff in a predetermined space; and
a knowledge generation unit configured to specify, from a second data set that includes a plurality of entities that form the space and have been grouped into groups of related entities, a group of entities described by words included in the extracted data, and to generate the inference-use knowledge that indicates a spatial relationship between the entities based on the specified group and a term expressing a preregistered spatial relationship.

2. The inference-use knowledge generation apparatus according to claim 1,
wherein the plurality of entities are grouped into groups of two related entities in the second data set, and
the knowledge generation unit is configured to generate, as the inference-use knowledge, a predicate-argument structure in which the two entities forming the specified group are used as terms.

3. The inference-use knowledge generation apparatus according to claim 1, further comprising
an inference-use knowledge storage unit configured to store the generated inference-use knowledge.

4. The inference-use knowledge generation apparatus according to claim 3,
wherein the knowledge generation unit is configured to extract, from case knowledge regarding the space, case knowledge at/in the designated position or region, and store the extracted case knowledge in the inference-use knowledge storage unit in association with the generated inference-use knowledge.

5. An inference-use knowledge generation method for generating inference-use knowledge that is to be used in an inference that is made by a calculating machine, the method comprising:
(a) a step of extracting, based on a set parameter, data corresponding to a designated position or region from a first data set including data regarding a stuff in a predetermined space; and
(b) a step of specifying, from a second data set that includes a plurality of entities that form the space and have been grouped into groups of related entities, a group of entities described by words included in the extracted data, and generating the inference-use knowledge that indicates a spatial relationship between the entities based on the specified group and a term expressing a preregistered spatial relationship.

6. The inference-use knowledge generation method according to claim 5,
wherein the plurality of entities are grouped into groups of two related entities in the second data set, and
in the (b) step, a predicate-argument structure in which the two entities forming the specified group are used as terms is generated as the inference-use knowledge.

7. The inference-use knowledge generation method according to claim 5, further comprising
(c) a step of storing the generated inference-use knowledge.

8. The inference-use knowledge generation method according to claim 7, further comprising
(d) a step of extracting, from case knowledge regarding the space, case knowledge at/in the designated position or region,
wherein in the (c) step, the extracted case knowledge is stored in association with the generated inference-use knowledge.

9. A non-transitory computer readable recording medium that includes a program recorded thereon for, with use of a computer, generating inference-use knowledge that is to be used in an inference that is made by a calculating machine, the program including instructions that cause the computer to carry out the steps of:
(a) a step of extracting, based on a set parameter, data corresponding to a designated position or region from a first data set including data regarding a stuff in a predetermined space; and
(b) a step of specifying, from a second data set that includes a plurality of entities that form the space and have been grouped into groups of related entities, a group of entities described by words included in the extracted data, and generating the inference-use knowledge that indicates a spatial relationship between the entities based on the specified group and a term expressing a preregistered spatial relationship.

10. The non-transitory computer readable recording medium according to claim 9,
wherein the plurality of entities are grouped into groups of two related entities in the second data set, and
in the (b) step, a predicate-argument structure in which the two entities forming the specified group are used as terms is generated as the inference-use knowledge.

11. The non-transitory computer readable recording medium according to claim 9, the program causing including instructions that cause the computer to further carry out the step of:
(c) a step of storing the generated inference-use knowledge.

12. The non-transitory computer-readable recording medium according to claim 11, the program including instructions that cause the computer to further carry out the step of:
(d) a step of extracting, from case knowledge regarding the space, case knowledge at/in the designated position or region,
wherein in the (c) step, the extracted case knowledge is stored in association with the generated inference-use knowledge.
